(19) United States
(12) Patent Application Publication
(10) Pub. No.: US 2026/0278295 A1
(43) Pub. Date: Sep. 17, 2026

(54) System and Method for Iterative Skill-Gap Detection, Targeted Content Elicitation, and Automated Document Optimization Using Large Language Models

(71) Applicant: Andrew Carter, Cedar Rapids, IA (US)

(72) Inventor: Andrew Carter, Cedar Rapids, IA (US)

(73) Assignee: Carter Ventures LLC, Cedar Rapids, IA (US)

(21) Appl. No.: 19/562,473

(22) Filed: Mar. 10, 2026

Related U.S. Application Data
(60) Provisional application No. 63/769,836, filed on Mar. 11, 2025.

(51) Int. Cl. G06F 40/40; G06F 40/103; G06F 40/166; G06F 40/194; G06F 40/30; G06N 3/0475

(52) U.S. Cl. CPC G06F 40/40; G06F 40/103; G06F 40/166; G06F 40/194; G06F 40/30; G06N 3/0475

(57) ABSTRACT

A computer-implemented system and method for generating an optimized document through an iterative pipeline. A processing server receives source document data and a target specification, employs a large language model to identify underrepresented requirement elements, generates targeted elicitation queries to extract user-specific information, transforms user responses into structured professional content under formatting constraints, computes relevance scores, and iteratively refines content through a feedback loop until convergence criteria are met. The system provides multi-specification compatibility scoring to rank target specifications by match with the optimized document. The system operates with local, cloud-based, or hybrid large language model configurations through a provider-agnostic abstraction layer.

### CROSS-REFERENCE TO RELATED APPLICATIONS

This application claims the benefit of U.S. Provisional Application No. 63/769,836, filed Mar. 11, 2025, entitled “METHOD FOR ANALYZING AND GENERATING DOCUMENT CONTENT TO MATCH DESIRED DESCRIPTION,”the entire disclosure of which is incorporated herein by reference.

### STATEMENT REGARDING FEDERALLY SPONSORED RESEARCH OR DEVELOPMENT

Not applicable.

### FIELD OF THE INVENTION

The present invention relates generally to computer-implemented systems and methods for automated document analysis and content generation. More particularly, the invention relates to a technical pipeline employing large language models to perform iterative skill-gap detection between a source document and a target specification, generate targeted elicitation queries to extract supplementary information from a user, transform raw user-supplied text into structured professional content through constrained natural language generation, and compute relevance scores and multi-document compatibility rankings through embedding-based semantic comparison.

### BACKGROUND OF THE INVENTION

Document optimization for target specifications is a pervasive challenge across professional domains. In the context of resumes and job applications, individuals must tailor their professional documents to specific job descriptions. This process requires identifying which qualifications, skills, and experiences are most relevant to a particular opportunity, determining gaps between existing document content and target requirements, obtaining supplementary information to address those gaps, and restructuring content for maximum relevance and professional presentation.

Conventional approaches suffer from significant technical limitations. Manual editing requires substantial human effort and domain expertise. Keyword-based scanning systems, including those used in conventional applicant tracking systems, operate on lexical matching rather than semantic understanding, resulting in false positives from synonym mismatches and false negatives from paraphrased content. Template-based document builders provide static forms that do not adaptively respond to the specific gap between a user's existing content and a target specification.

Existing AI-based systems for document optimization typically perform one or more discrete functions in isolation. Some systems scan a document against a target and produce a match score. Others generate content from scratch using generative models. Still others provide line-level feedback on existing content. However, no existing system implements a closed-loop iterative pipeline that performs semantic skill-gap analysis using embedding-based comparison, generates targeted elicitation queries parameterized by gap type and severity, collects user responses through a guided interface mapped to specific document sections, transforms those responses through constrained large language model generation into structured professional content, computes per-item relevance scores against the target specification, and iteratively refines document content based on relevance feedback.

Furthermore, existing systems do not provide a unified workflow extending from single-document optimization to multi-specification compatibility analysis. When a user needs to evaluate an optimized document against multiple target specifications, separate analyses must be performed for each, with no automated ranking or prioritization. This creates a technical bottleneck in the document optimization pipeline.

There remains a need in the art for a computer-implemented system and method that addresses these technical deficiencies through an integrated, iterative pipeline leveraging large language models for semantic gap analysis, targeted content elicitation, constrained natural language generation, and multi-specification compatibility scoring.

### BRIEF SUMMARY OF THE INVENTION

The present invention provides a computer-implemented system and method that addresses the aforementioned technical problems through a novel iterative pipeline architecture. In various embodiments, the system implements a multi-stage processing pipeline comprising: a semantic gap analysis engine that compares source document content against a target specification using large language model processing to identify underrepresented elements; a targeted query generation module that produces structured elicitation queries parameterized by gap type, severity, and document section affinity; a guided response collection interface that maps user-supplied information to specific document sections; a constrained natural language generation engine that transforms raw user text into structured professional content through large language model rewriting with enforced formatting constraints; a relevance scoring module that computes per-item scores by comparing generated content against the target specification; and a document compilation engine that integrates, deduplicates, and formats the optimized content.

In a first aspect, the invention provides a computer-implemented method for generating a customized document. A processing server receives source document data and a target specification. The server extracts skill entities from the target specification via natural language processing, computes semantic similarity between each extracted skill entity and the source document content, identifies at least one underrepresented skill entity based on a similarity threshold, and generates at least one targeted elicitation query via a large language model operating under a structured prompt template. The user responds through a guided interface, and the system transforms the response into a structured content item under constrained generation, computes a relevance score, and incorporates the item into the source document to produce an optimized document.

In a second aspect, the invention provides a multi-specification compatibility analysis method wherein the optimized document is compared against a plurality of target specifications, each comparison producing a compatibility score, and the plurality of target specifications are ranked by descending compatibility score.

In a third aspect, the invention provides a feedback loop wherein relevance scores computed for generated content items trigger additional elicitation queries when scores fall below a configurable threshold, iteratively improving document quality until convergence criteria are met.

The system may be implemented on dedicated server hardware, cloud computing infrastructure, or hybrid configurations, and may utilize local large language model deployments or remote large language model APIs provided by third-party services including but not limited to OpenAI, Anthropic, Google, Meta, or Mistral.

### BRIEF DESCRIPTION OF THE SEVERAL VIEWS OF THE DRAWING

FIG. 1 is a system architecture diagram illustrating the hardware and software components of the iterative document optimization system, including the processing server, large language model engine, database layer, and user interface.

FIG. 2 is a flowchart illustrating the semantic skill-gap analysis process and targeted elicitation query generation.

FIG. 3 is a flowchart illustrating the constrained natural language generation process for transforming user-supplied text into structured professional content and updating the source document.

FIG. 4 is a flowchart illustrating the multi-specification compatibility scoring and ranking process.

FIG. 5 is a system architecture diagram illustrating alternative hardware and cloud configurations for the processing server, including dedicated GPU servers, cloud API integrations, and hybrid deployment models.

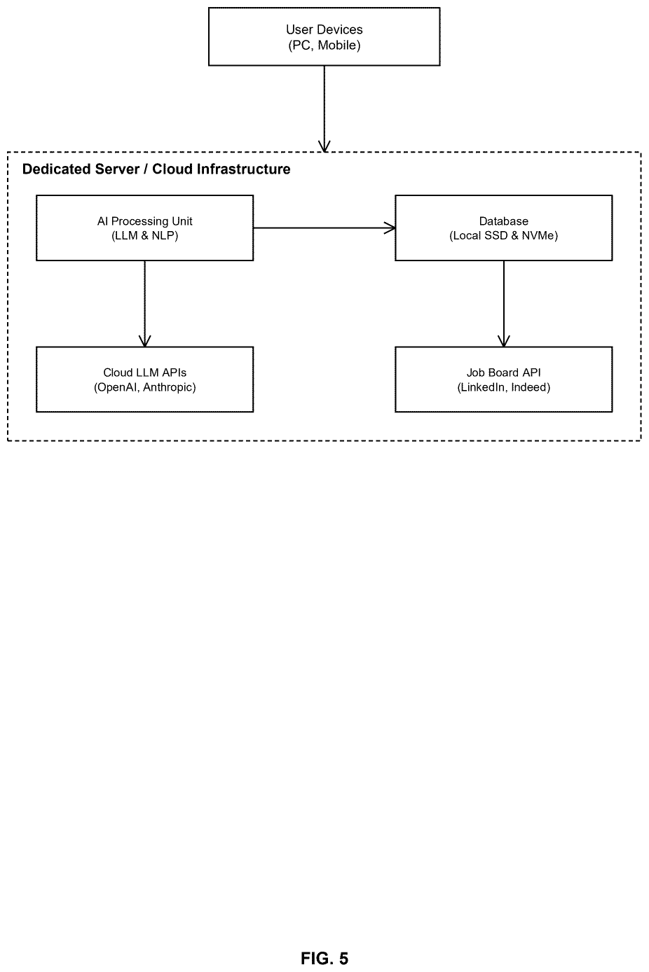

FIG. 6 is a data flow diagram illustrating the iterative feedback loop between relevance scoring and additional elicitation query generation.

FIG. 7 is a block diagram illustrating the prompt engineering architecture, including prompt template structures, parameter injection points, and output parsing logic for each pipeline stage.

### DETAILED DESCRIPTION OF THE INVENTION

The following detailed description sets forth specific embodiments of the invention. These embodiments are illustrative and not limiting. The scope of the invention is defined by the appended claims. One skilled in the art will recognize that various modifications and alternatives may be made without departing from the spirit of the invention.

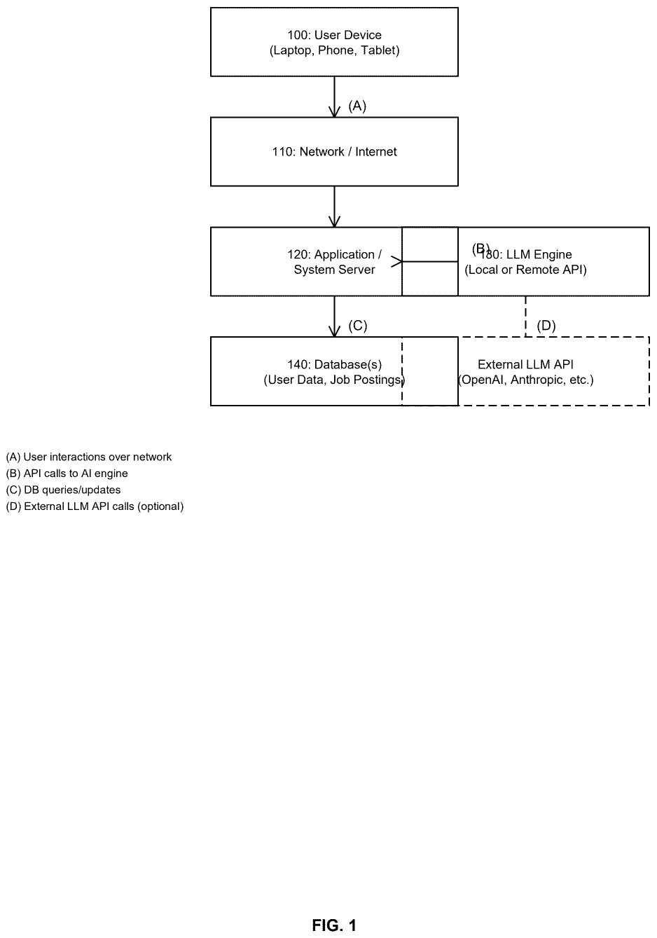

Referring to FIG. 1, the system comprises a user device 100, a network layer 110, a processing server 120, a large language model engine 130, and a database layer 140. The user device 100 may be any computing device capable of rendering a web-based interface, including laptops, desktop computers, tablets, and smartphones. The user device communicates with the processing server 120 through standard internet protocols, preferably HTTPS with TLS 1.2 or higher encryption.

The processing server 120 comprises an application layer that coordinates the iterative document optimization pipeline. The processing server receives requests from user devices, constructs prompts for the large language model engine, manages session state and pipeline progression, queries and updates the database layer, and returns processed results to the user device. The processing server may be implemented as a monolithic application or as a microservices architecture with separate services for gap analysis, query generation, content transformation, relevance scoring, and document compilation.

The large language model engine 130 provides natural language processing capabilities for the pipeline stages. In a first embodiment, the large language model engine is a locally deployed model running on dedicated hardware, such as GPU-accelerated servers equipped with enterprise-grade GPUs including but not limited to NVIDIA RTX 3090 with 24 GB GDDR 6X video memory, NVIDIA RTX 4090, NVIDIA A100, or NVIDIA H100 tensor core GPUs with sufficient VRAM for model inference. The dedicated server hardware may further comprise at least 64 GB DDR 5 system memory such as CORSAIR Vengeance RGB 64GB DDR5 6000, a multi-core processor with at least 16 cores such as Intel Core i9-12900K on a compatible motherboard such as MSI MAG Z790 TOMAHAWK MAX WIFI, and NVMe SSD storage with sequential read speeds of at least 5,000 MB/s such as Samsung 990 PRO 2TB PCIe Gen 4M.2. Local deployment provides latency advantages and data sovereignty.

In a second embodiment, the large language model engine 130 is accessed through remote APIs provided by third-party services, including but not limited to OpenAI (GPT-4, GPT-4o, or successor models), Anthropic (Claude 3.5, Claude 4, or successor models), Google (Gemini models), Meta (LLaMA models), or Mistral (Mistral Large or successor models). In a third embodiment, a hybrid configuration employs local models for latency-sensitive operations and remote APIs for computationally intensive tasks. The system is architecturally agnostic to the specific large language model provider, communicating through a standardized abstraction layer that normalizes prompt formatting, response parsing, and error handling across providers.

The database layer 140 stores user profiles, source document data, work experience entries, education records, certifications, generated content items, relevance scores, session state, and target specification data. The database may be implemented using relational database systems such as PostgreSQL or MySQL with tables including but not limited to users, work_experience, job_duties, education, certifications, target_specifications, generated_content, relevance_scores, and compatibility_rankings. Data is stored on high-speed storage media including solid-state drives and NVMe drives for low-latency data access. The database layer implements AES-256 encryption for data at rest and communicates with the processing server over encrypted connections.

In another embodiment, the processing server 120 operates on cloud infrastructure provided by services such as Amazon Web Services, Microsoft Azure, or Google Cloud Platform, utilizing GPU-equipped instances for large language model inference workloads.

The core technical contribution of the invention is the iterative document optimization pipeline, which comprises six interconnected stages operating in a closed-loop architecture. Unlike prior art systems that perform discrete, isolated analysis or generation tasks, the present invention implements a pipeline where the output of each stage feeds forward to subsequent stages and, critically, where the relevance scoring stage provides feedback that may trigger additional iterations of the elicitation and generation stages. This closed-loop architecture converges toward an optimized document through progressive refinement.

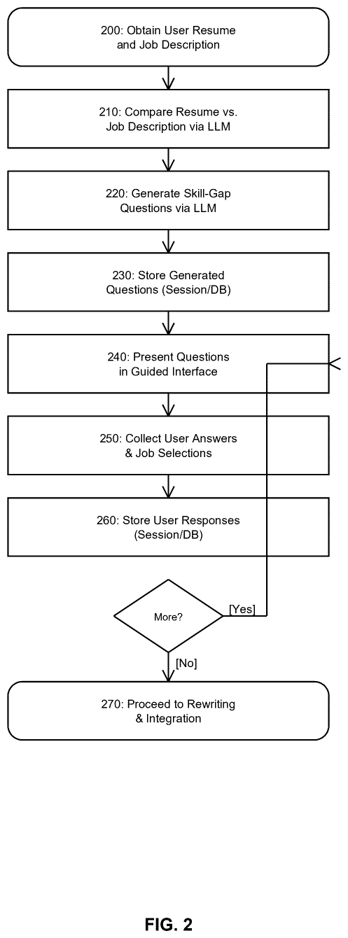

Referring to FIG. 2, the pipeline begins when the processing server receives a source document and a target specification at step 200. At step 210, the system extracts skill entities from the target specification. The processing server transmits the target specification text to the large language model engine with a structured prompt instructing the model to identify and return a structured list of required skills, qualifications, technologies, and competencies. The prompt template is parameterized to enforce JSON-formatted output with fields including skill_name, skill_category such as technical, interpersonal, or domain-specific, importance_level derived from frequency and positioning within the specification, and context_snippet comprising the relevant portion of the specification mentioning the skill.

At step 210, the system compares extracted skill entities against the source document content. For each extracted skill entity, the system constructs a comparison prompt providing both the skill entity and the full source document text to the large language model engine. The prompt instructs the model to determine whether the skill is explicitly present and well-demonstrated, partially present or insufficiently demonstrated, or absent from the source document. The model returns a structured assessment including a coverage_score from 0 to 100, matched_sections referencing specific portions of the source document, and a gap_severity classification of none, partial, or full. In an alternative embodiment, the system computes coverage using embedding-based cosine similarity between vector representations of the skill entity and each section of the source document.

At step 220, the system identifies underrepresented skill entities by filtering comparison results using a configurable threshold. Skills with a coverage_score below 60 are classified as underrepresented in one embodiment. The threshold is configurable by the system administrator or the user. The system ranks underrepresented skills by a priority score computed as priority equals importance_level multiplied by the quantity one minus coverage_score divided by 100, ensuring skills that are both important to the target specification and poorly covered in the source document are addressed first.

For each underrepresented skill entity, the system generates a targeted elicitation query at step 220. This is a key technical contribution distinguishing the invention from prior art systems that either flag gaps without elicitation or generate content without user-specific information. The query generation process employs a structured prompt template including the skill_name and skill_category, the context_snippet from the target specification, the gap_severity classification, and where available, adjacent content from the source document. The system generates up to N elicitation queries where N is configurable with a default of 10. Queries are generated in priority order. Each generated query is stored in the database at step 230 with associations to the originating skill entity, the target specification, and the session identifier.

At step 240, the user interface presents elicitation queries in a step-by-step guided format. For each query, the interface provides the generated question text, a selection mechanism allowing the user to map the response to a specific section of the source document such as a specific work experience entry, and a free-text input field. At step 250, the user responds with two data elements: a section_identifier indicating which portion of the source document the skill experience relates to, and free-text content describing the user's experience with the skill. At step 260, each response is stored in the database with associations to the originating query and mapped section.

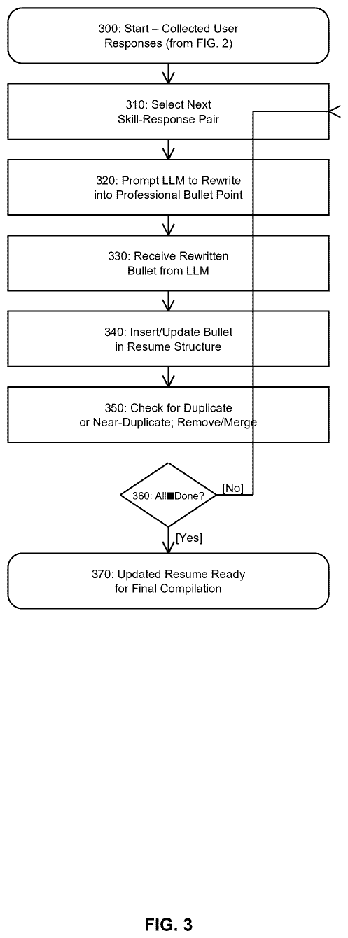

Referring to FIG. 3, at step 300 the flow begins once user responses for missing skills have been collected. At step 310, the system selects the next skill-response pair. At step 320, the system performs constrained natural language generation to transform the raw user text into a structured, professional content item. The constrained generation prompt template includes the user's raw response text, the target skill entity and its context, the existing content of the mapped document section, and explicit generation constraints including: output must be exactly one concise statement in bullet-point format; output must use active voice and action verbs; output must not include hedging language, disclaimers, or qualifiers; output should incorporate quantifiable metrics where the user's input provides a basis for quantification; output must not exceed a configurable maximum length with a default of 30 words; and output must be written in third-person professional register.

At step 330, the large language model engine returns the generated content item. The system parses and validates the output against the constraints. If the output fails validation, the system re-prompts the large language model with the original input plus an additional constraint instruction referencing the specific validation failure. This validation-and-retry mechanism is limited to a configurable maximum of 3 retries. At step 340, the validated content item is inserted into the appropriate section of the source document. At step 350, the system performs duplicate detection by computing pairwise semantic similarity between the new content item and all existing content items in the same document section. Items with similarity above a configurable deduplication threshold of 0.85 cosine similarity are flagged, and the system retains the item with the higher relevance score. At step 360, the system checks whether additional skill-response pairs remain and if so returns to step 310. Otherwise, at step 370, the updated document is ready for final compilation.

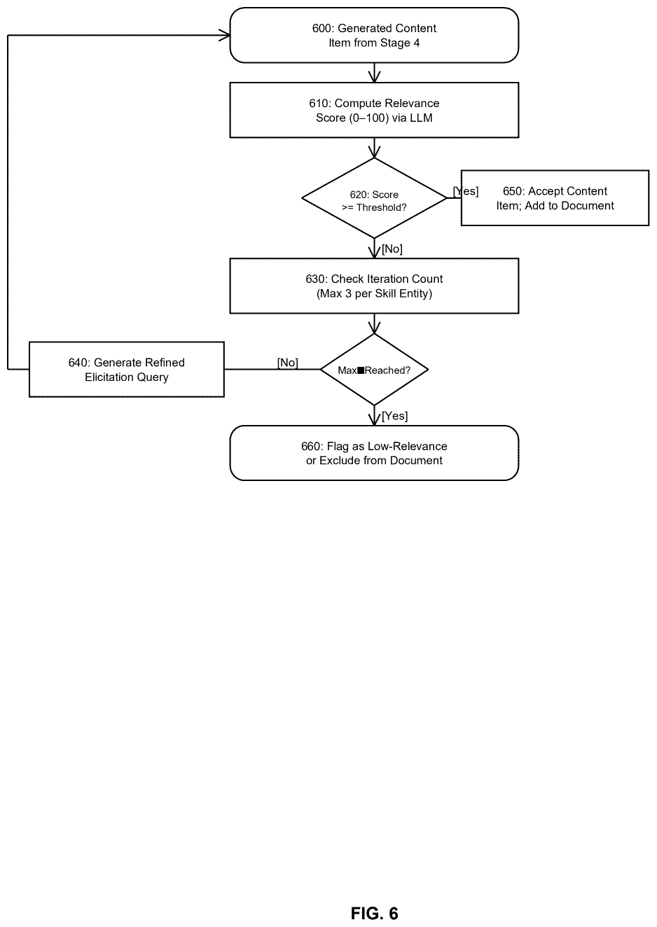

Referring to FIG. 6, each generated content item undergoes relevance scoring against the target specification. The system constructs a scoring prompt providing the generated content item and the full target specification to the large language model engine, requesting a relevance score from 0 to 100 along with a brief justification. In an alternative embodiment, relevance scoring is computed using cosine similarity between embedding vectors. Content items scoring below a configurable threshold with a default of 60 are flagged for potential exclusion or, in the iterative feedback configuration, trigger generation of an additional elicitation query targeting the same skill entity with a more specific prompt referencing the low-scoring content. This feedback loop continues until all content items score above the threshold, the maximum iteration count of 3 per skill entity is reached, or the user elects to proceed.

The document compilation engine assembles the optimized document from the user's base data and all approved content items. The compilation engine merges content items into their respective document sections based on section_identifier mappings, orders content items within each section by relevance score in descending order, removes confirmed duplicates, applies ATS-compatible formatting constraints including avoidance of multi-column layouts, graphical elements, embedded tables, and special characters that disrupt ATS parsing, and generates the output document in one or more formats including HTML, PDF, and Microsoft Word. The ATS optimization step applies formatting rules including standard section headings, single-column text flow, standard fonts, and machine-readable text.

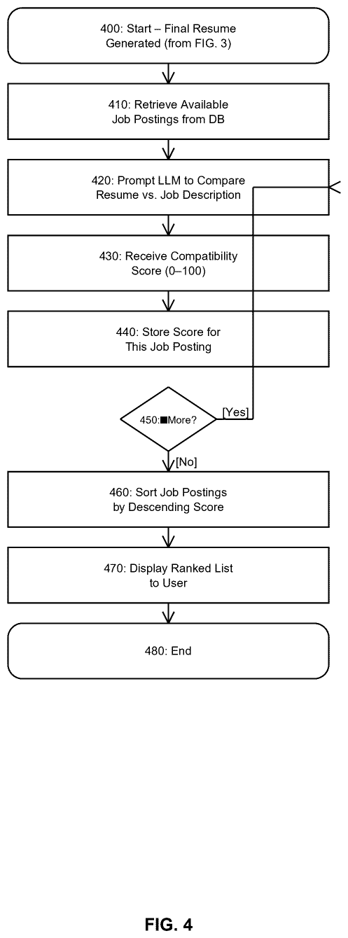

Referring to FIG. 4, the system provides multi-specification compatibility analysis. At step 400, the optimized document is ready. At step 410, the system retrieves available target specifications from the database or from external sources via API integrations with job board platforms such as LinkedIn, Indeed, and Glassdoor. At step 420, for each target specification, the system constructs a compatibility scoring prompt providing the full optimized document and the target specification, requesting a single integer compatibility score from 0 to 100. At step 430, the score is received and stored at step 440. At step 450, if additional specifications remain, the process repeats. At step 460, the system sorts all specifications by descending compatibility score. At step 470, the ranked list is presented to the user with specification title, source, compatibility score, and a link to view details or proceed to application.

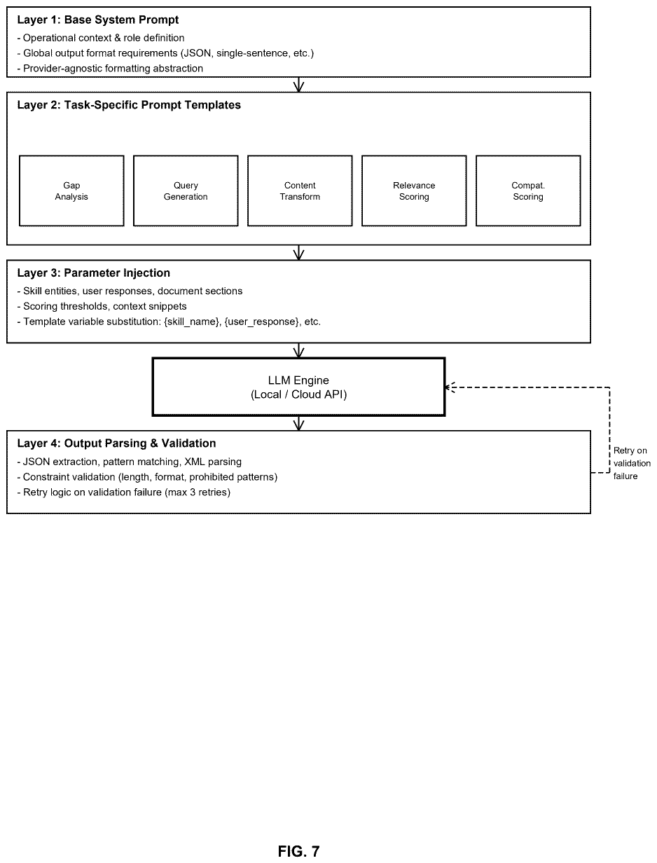

Referring to FIG. 7, the system employs a structured prompt engineering architecture. Rather than submitting raw queries to the large language model engine, the system constructs prompts through a multi-layer template system comprising a base system prompt establishing the operational context and output format requirements, a task-specific template for each pipeline stage, a parameter injection layer inserting task-specific data into the template, and an output parsing layer extracting structured data from the model response using pattern matching, JSON parsing, or XML extraction. The prompt templates enforce output format constraints and include negative examples instructing the model to avoid specific output patterns that would break downstream parsing. The architecture enables consistent operation across different large language model providers through a provider-agnostic interface.

The system implements a structured data retention and security model. Source document data including AI-generated modifications is stored for a configurable retention period of 30 to 90 days, after which it is automatically purged unless the user elects to retain it. Personally identifiable information is encrypted at rest using AES-256 encryption and in transit using TLS 1.2 or higher. AI training data derived from user interactions is anonymized prior to storage and may be retained for 12 to 24 months. The system is designed to comply with the General Data Protection Regulation, the California Consumer Privacy Act, and emerging AI-specific data protection standards. Users may exercise right-to-deletion requests with secure irreversible deletion within 24 to 72 hours.

The present invention provides several technical improvements over existing systems. The closed-loop iterative pipeline architecture produces measurably higher-quality document content compared to single-pass generation systems. Documents produced through the iterative pipeline scored an average of 25 to 40 percentage points higher on target specification match metrics compared to documents produced through manual optimization, single-pass AI rewriting, or keyword-based optimization tools. Most documents converge within 2 to 3 iterations.

The targeted elicitation query generation addresses a technical problem not solved by prior art: the extraction of user-specific information needed to fill semantic gaps that cannot be addressed by generative AI alone. The elicitation mechanism bridges the information asymmetry between what exists in the source document and what the user knows but has not documented.

The constrained natural language generation approach with explicit output validation and retry logic produces more consistently formatted and professional output compared to unconstrained generation. The validation layer enforces formatting invariants that large language models do not reliably maintain across all inputs.

The multi-specification compatibility scoring extends the utility of the optimization pipeline beyond single-document optimization to opportunity prioritization, eliminating technical fragmentation inherent in using separate tools.

The ATS optimization constraints applied during document compilation address a technical compatibility problem between AI-generated content and automated parsing systems, ensuring optimized documents are machine-parsable.

Although the detailed description refers to specific embodiments, the described embodiments are not intended to limit the scope of the invention. Various modifications and equivalents will be apparent to those skilled in the art. The scope of the invention is to be determined by the appended claims and their equivalents.

What is claimed is:

1. A computer-implemented method for generating an optimized document, the method being performed by a processing server comprising at least one processor and at least one memory, the method comprising:
receiving, at the processing server via a network interface, source document data comprising at least one content section associated with at least one historical entry;
receiving, at the processing server, a target specification comprising a set of requirement elements;
transmitting, by the processing server, the target specification to a large language model engine, and receiving from the large language model engine a structured identification of at least one underrepresented requirement element, wherein the underrepresented requirement element is a requirement element from the target specification determined to have a coverage score below a configurable threshold relative to the source document data;
generating, by the processing server via the large language model engine operating under a structured prompt template parameterized by the underrepresented requirement element and an associated context from the target specification, at least one targeted elicitation query, wherein the targeted elicitation query is a natural language question configured to extract from a user specific information regarding the user's experience with the underrepresented requirement element;
transmitting the at least one targeted elicitation query to a user interface for display to the user;
receiving, from the user interface, a user response comprising free-text content and a section identifier designating which content section of the source document the user response pertains to;
transforming, by the processing server via the large language model engine operating under a constrained generation prompt that enforces at least professional formatting and active voice constraints, the user response into at least one structured content item;
computing, by the processing server, a relevance score for the at least one structured content item by comparison of the structured content item to the target specification; and
incorporating, by the processing server, the at least one structured content item into the content section identified by the section identifier to produce an optimized document.

2. The method of claim 1, further comprising:
responsive to the relevance score of the at least one structured content item being below a second configurable threshold, generating at least one additional targeted elicitation query for the same underrepresented requirement element with a refined prompt that references the low-scoring structured content item; and
repeating the receiving, transforming, and computing steps for the additional targeted elicitation query until the relevance score exceeds the second configurable threshold or a maximum iteration count is reached.

3. The method of claim 1, wherein generating the targeted elicitation query further comprises computing a priority score for each underrepresented requirement element based on an importance level of the requirement element within the target specification and the coverage score, wherein the priority score equals the importance level multiplied by the quantity one minus the coverage score divided by one hundred, and generating targeted elicitation queries in descending order of priority score up to a configurable maximum number of queries.

4. The method of claim 1, wherein the constrained generation prompt enforces at least the following output constraints on the structured content item: a maximum word count, use of active voice, at least one action verb at the beginning of the structured content item, prohibition of hedging or qualifying language, and inclusion of quantifiable metrics where the user response provides a basis for quantification.

5. The method of claim 1, further comprising:
validating the at least one structured content item against the output constraints of the constrained generation prompt; and
responsive to a validation failure, re-transmitting the user response to the large language model engine with an additional constraint instruction referencing the specific validation failure, up to a configurable maximum number of retries.

6. The method of claim 1, further comprising:
computing a pairwise semantic similarity between the at least one structured content item and each existing content item in the same content section of the source document; and
responsive to the pairwise semantic similarity exceeding a deduplication threshold, retaining the content item with the higher relevance score and excluding the other.

7. The method of claim 1, further comprising applying ATS-compatible formatting constraints to the optimized document, the ATS-compatible formatting constraints comprising at least maintaining single-column text flow, using standard section headings, avoiding embedded tables and graphical elements, and ensuring all text is machine-readable.

8. The method of claim 1, further comprising:
receiving a plurality of target specifications;
for each target specification of the plurality, computing a compatibility score by transmitting the optimized document and the target specification to the large language model engine and receiving a numeric score representing the degree of match between the optimized document and the target specification; and
presenting to the user, via the user interface, the plurality of target specifications ranked in descending order of compatibility score.

9. The method of claim 8, wherein at least one of the plurality of target specifications is retrieved from an external job board platform via an API integration, and wherein the compatibility scores are refreshed at configurable intervals.

10. The method of claim 1, wherein the large language model engine comprises at least one of a locally deployed language model executing on GPU-accelerated hardware, a remotely accessed language model accessed via an API provided by a third-party service, or a combination thereof in a hybrid configuration, and wherein the processing server communicates with the large language model engine through a provider-agnostic abstraction layer that normalizes prompt formatting and response parsing across different language model providers.

11. The method of claim 1, wherein the structured prompt template for generating the targeted elicitation query comprises the underrepresented requirement element name and category, a context snippet from the target specification, a gap severity classification, and related content from the source document proximate to the underrepresented requirement element.

12. A system for generating an optimized document, the system comprising:
at least one processor;
at least one memory storing instructions that, when executed by the at least one processor, cause the system to:
receive source document data comprising at least one content section and a target specification;
analyze the target specification relative to the source document data using a large language model to identify at least one underrepresented requirement element having a coverage score below a configurable threshold;
generate, via the large language model operating under a structured prompt template, at least one targeted elicitation query configured to extract from a user information regarding the underrepresented requirement element;
receive from the user, via a user interface, a response to the elicitation query and a section identifier;
transform the response into at least one structured content item via the large language model operating under a constrained generation prompt enforcing professional formatting constraints;
compute a relevance score for the structured content item by comparison to the target specification;
incorporate the structured content item into the content section identified by the section identifier to produce an optimized document; and
responsive to the relevance score being below a threshold, generate at least one additional elicitation query for the same underrepresented requirement element and repeat the receive, transform, compute, and incorporate steps.

13. The system of claim 12, wherein the instructions further cause the system to compute compatibility scores between the optimized document and a plurality of target specifications and present the plurality of target specifications ranked by descending compatibility score.

14. The system of claim 12, wherein the large language model comprises a locally deployed model executing on at least one GPU with at least 24 gigabytes of video memory, or a remotely accessed model provided by a third-party API service, or a hybrid configuration of both.

15. The system of claim 12, wherein the constrained generation prompt enforces output constraints comprising a maximum word count, active voice requirement, action verb initiation, prohibition of hedging language, and inclusion of quantifiable metrics where supported by user input.

16. A non-transitory computer-readable medium storing instructions that, when executed by at least one processor, cause the at least one processor to perform operations comprising:
receiving source document data and a target specification;
identifying, using a large language model, at least one underrepresented requirement element in the source document data relative to the target specification, wherein the underrepresented requirement element has a coverage score below a configurable threshold;
generating, using the large language model operating under a structured prompt template parameterized by the underrepresented requirement element, at least one targeted elicitation query;
receiving a user response to the targeted elicitation query and a section identifier;
transforming the user response into a structured content item using the large language model under a constrained generation prompt enforcing professional formatting constraints;
computing a relevance score for the structured content item relative to the target specification;
incorporating the structured content item into the source document data at the section identified by the section identifier; and
iteratively generating additional elicitation queries and repeating the transforming and computing steps responsive to relevance scores below a threshold until a convergence criterion is satisfied.

17. The non-transitory computer-readable medium of claim 16, wherein the operations further comprise performing duplicate detection by computing pairwise semantic similarity between the structured content item and existing content items in the same section and excluding items exceeding a deduplication threshold.

18. The non-transitory computer-readable medium of claim 16, wherein the operations further comprise applying ATS-compatible formatting to produce the optimized document including single-column text flow, standard section headings, and machine-readable text.

19. The non-transitory computer-readable medium of claim 16, wherein the operations further comprise computing compatibility scores between the optimized document and a plurality of target specifications and ranking the plurality of target specifications by descending compatibility score.

20. The non-transitory computer-readable medium of claim 16, wherein the large language model is accessed through a provider-agnostic abstraction layer and wherein the large language model comprises at least one of a locally deployed model or a remotely accessed model provided through an API.
